(19) United States
(12) Patent Application Publication
(10) Pub. No.: US 2007/0136342 A1
(43) Pub. Date: Jun. 14, 2007

(54) Processing a user inquiry

(75) Inventors: Prashant Kumar Singhai, Bangalore (IN); Satyesh Singh, Bangalore (IN)

Correspondence Address: KENYON & KENYON LLP, ONE BROADWAY, NEW YORK, NY, 10004, US

(73) Assignee: SAP AG

(21) Appl. No.: 11/302,995

(22) Filed: Dec. 13, 2005

(51) Int. Cl. G06F 7/00

(52) U.S. Cl. 707/101

(57) ABSTRACT

Processing a user inquiry includes receiving the user inquiry from an input source. The inquiry may then be processed by a processing device to determine various inquiry factors. These factors provide an indication of the content of the inquiry, such as words associated with particular problems, the software or hardware at issue, version information, and other information. The processing device then searches a database using the inquiry factors to retrieve solution information. This solution information includes information regarding troubleshooting and fixing different problems that the user may have encountered. A solution document is generated using this solution information. Using a routing device, the solution document and the user inquiry is thereupon provided to a support assistant to provide directed support to the user.

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to processing user inquiries regarding issues relating to one or more processing environments, and more specifically to specialized user assistant based on specifics of a users inquiry.

It is common for problems to arise in processing environments, including software applications, hardware configurations or combinations thereof. In addition to providing a processing environment, users are also typically provided customer service options relating to diagnosing, troubleshooting and subsequently fixing any problem.

Current approaches include various techniques for allowing a user to submit a question or other type of inquiry. One common approach is through a computing interface. For example, a user using a web site may find a help section that may include Frequently Asked Questions (FAQs for short). The user may be able to select the FAQs and manually scroll through these documents. If the problem is a common problem, the user may very likely find the problem in this section and follow the written instructions or steps to resolve the problem. Although, the FAQs are restricted to the listing of known issues. FAQs also require a user to manually navigate through these listings to find the appropriate solution. Therefore, if a user's problem does not match the listed elements in the FAQ section, the user may need further information to resolve any problems.

Another approach is allowing a user to conduct a search through either an FAQ or a solution database. This inquiry includes a user entering a key word and a search engine searches one or more databases of information. Once again, this is limited by the databases and the information stored therein. Furthermore, this is also limited by a user's ability to properly enter key words for searching. The problem can be further complicated with processing environments having varied software and/or hardware configurations. For example, a step by step solution for one version of a software application may not necessarily work for a second version of the software application.

A more common approach is direct interaction with a customer service agent. It is not uncommon for a user to either directly access a customer service agent, such as through a telephone connection or via a web portal application. The interaction may be telephonic or computer based regarding the user-described problems or concerns that necessitated the contact. The assistant then attempts to troubleshoot the problem and provide a quick resolution.

The customer service agents utilize their own manuals and rely on their own levels of expertise. For example, through directed questions, the agent may determine the software or hardware at issue, the version information and possible symptoms. From these questions, the agent may search a manual to find the answer, where the manual is typically a large electronic file or database of files providing specific instructions for different problems.

This approach is a very general approach and often times the quality of assistance is dictated by the agent's ability. For example the experience level of the agent may greatly determine how easily the customer is afforded a solution. Also, different agents will have different experience levels with different problems, depending on various factors including if the agent has encountered a particular problem before.

The quality of the agent is not as particular with common problems. Manuals and training provide that even the most inexperienced agents are capable of solving routine issues. Although, with specialized issues, the experience of the agent can be the difference between a problem being solved and not, or the solution occurring in a short time or over a long drawn out process. As each agent performs different tasks, the agent's experience level grows. With common problems, it is more likely that most agents have dealt with these specific issues before.

In larger applications, such as system wide applications having multiple users and a large number of features and functionality, such as a customer resource management (CRM) application, there may be a wide variety of user concerns that arise. With uncommon problems, it becomes a lot less likely that agent is experienced in solving the problems. Therefore, even though a particular agent may experience in a particular area by having encountered the issue before, the current systems do not provide for specialization of the agent's ability and simply provides user requests to available agents.

### BRIEF DESCRIPTION OF THE DRAWINGS

FIG. 1 illustrates a block diagram of one embodiment of a user inquiry processing device;

FIG. 2 illustrates a graphical representation of processing steps performed by the processing device of FIG. 1;

FIG. 3 illustrates a graphical representation of alternative databases available in the user inquiry processing device of FIG. 1;

FIG. 4 illustrates a graphical representation of one embodiment of data generated by the processing device of FIG. 1;

FIG. 5 illustrates a flowchart of the steps of one embodiment of a method for processing a user inquiry; and

FIG. 6 illustrates a block diagram of another embodiment of a user inquiry processing device.

### DETAILED DESCRIPTION

Generally, processing a user inquiry includes receiving the user inquiry from an input source. The inquiry may then be processed by a processing device to determine various inquiry factors. These factors provide an indication of the content of the inquiry, such as words associated with particular problems, the software or hardware at issue, version information, and other information. The processing device then searches a database using the inquiry factors to retrieve solution information. This solution information includes information regarding troubleshooting and fixing different problems that the user may have encountered. A solution document is generated using this solution information. Using a routing device, the solution document and the user inquiry is thereupon provided to a support assistant to provide directed support to the user.

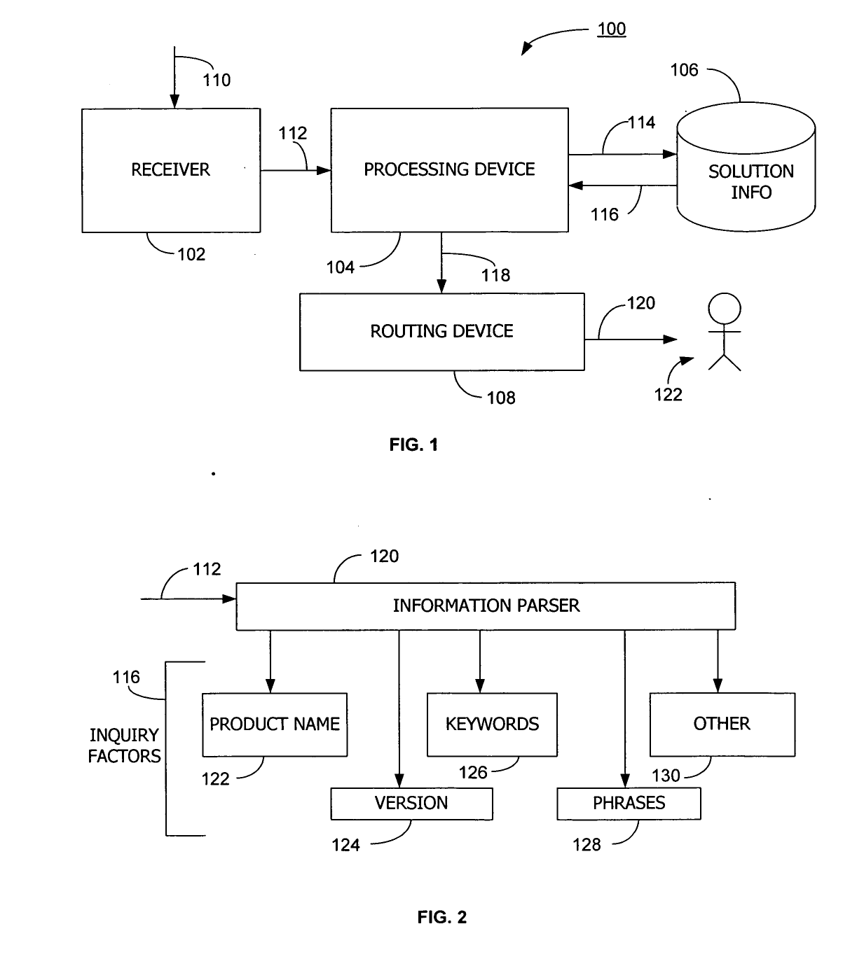

More specifically, FIG. 1 illustrates a processing system 100 including a receiver 102, a processing device 104, a solution information database 106 and a routing device 108. The receiver 102 may be a device implemented in hardware, software or a combination thereof for receiving incoming data using a transmission medium through a portal or other access point to the system 100. The processing device 104 may be one or more processing elements, either self-contained or interconnected across one or more networks where the processing device 104 is operative to perform processing steps in response to executable instructions.

The solution information database 106 may be one or more databases having solution information stored therein, where the database 106 communicates with the processing device 104 to allow searching and subsequent data retrieval therefrom. The routing device 108 may be a device, implemented in hardware, software or a combination thereof, for routing information between the processing device and one or more designated destinations.

In the system 100, the receiver 102 receives an input message 110 that includes a user inquiry. The receiver 102 may parse any overhead or additional information from the input message 110, such as routing information, and extract the input message therefrom. The receipt of this input message 110 may be from various portals, such as through a web site, an email address or any other suitable portal. For example, the portal may be a help section of a web site where a user may electronically submit an inquiry by filling out an online form, including the user's identification and a description of the problem. Once the form is completed, it may be converted to the message 110 and provided to the receiver 102, where the system 100 may be at a remote location and accessible through networking techniques.

The receiver 102 thereupon provides the user inquiry 112 to the processing device 104. The inquiry 112 includes text and other input information designating the user's problems. The processing device 104 may perform executable operations to extract elements of the inquiry 112. FIG. 2 illustrates a block diagram of an information parser 120, which may be a software module executed by the processing device. The parser 120 receives the user inquiry 112 and extracts different elements that it deems to be important. The guidelines controlling the extraction of different elements from the parser 120 may be adjusted based on different scenarios or topical to the application(s) to which the user inquires are likely to be directed.

In the exemplary embodiment of FIG. 2, the parser 120 generates five separate lists of data elements. The exemplary designated lists are product names 122, version information 124, keywords 126, phrases 128 and other information 130. The lists, when generated from the inquiry 112 may be used to determine the inquiry factors 114 that may be used to search the solution information database 106.

Using known data parsing techniques, various elements from the user inquiry 112 are examined and if they meet various criteria, they are then added to the corresponding list of inquiry factors 114. For example, if a name of a software product is in the inquiry 112, that name may be added to the product name list 122. Similarly, if a number or version code name is included, that may be added to the version information list 124.

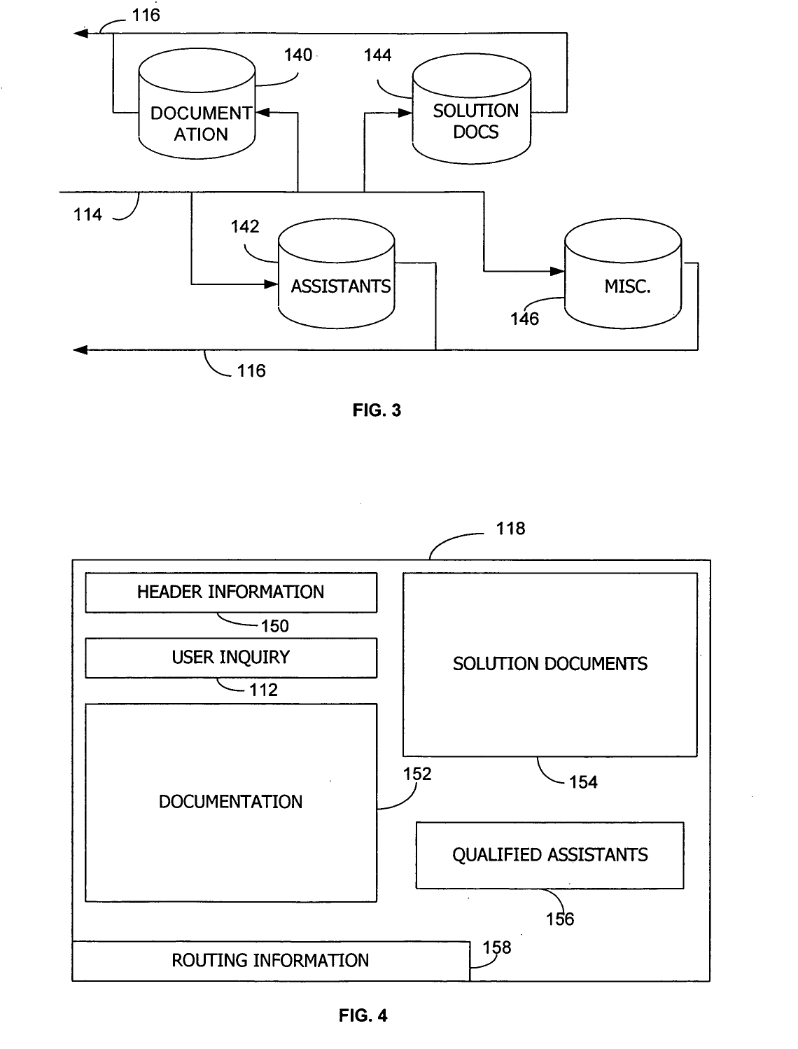

The processing device 104 thereupon performs a search of the database 106 using the inquiry factors 114. The solution information database 106 may be one or more databases having various type of information relating to troubleshooting and solving user concerns. For example, FIG. 3 illustrates a graphical representation of various exemplary databases that may be including or associated with the solution information database 106. A documentation database 140 may include documentation relating to different hardware and software concerns. For example, the documentation may include manuals, updates, news releases, product specification information and other information. An assistants database 142 may include profiles of the different support assistants that are capable of assisting with the user inquiry. The database 142 may include information as to specific assistants or may include more generalized information regarding experience classification levels, for example an indication that all assistants over a certain experience level are qualified in specific user issues.

A solution documents database 144 may include numerous solution documents, as discussed in greater detail below. These documents are generated by the processing device 104 in response to the user inquiry 112 and may contain information usable by a support assistant. A miscellaneous database 146 may include other information not specifically designated for storage in the documentation database 140, the assistants database 142 and the solution documents database 144.

In one embodiment, the miscellaneous database 146 may include one or more charts or trees relating to known customer concerns. For example, the database 146 may include problem trees that are directed to walking the assistant through various steps to accurately determine a particular problem. The problem tree may be an interactive electronic document include processing various input answers by the assistant based on input from the user, where processing routines thereupon advance the process to the next step of the tree. The problem tree may also be a flowchart include manual navigation based on user responses. Regardless of the specific formatting, the decision tree may be included in the database 146, or any other database, and is retrievable based on the inquiry factors. In another example, the database 146 may include decision trees, which like the problem trees, allow for iterative feedback step functions. Although the decisions trees provide iterative steps relating to solving a user problem, where the assistant may walk through the steps of the decision tree in aiding the user to correct the user's noted problem(s).

It is also noted that the solution information database 106, and including the exemplary databases 140, 142, 144 and 146 of FIG. 3, may be actively updated so that the search request may retrieve the most current information, as discussed in further detail below.

The solution information database 106, in response to the inquiry factors 114, provides solution information 116 back to the processing device 104. As also illustrated in FIG. 3, the databases 140, 142, 144 and 146 may provide solution information 116 in response to the search request using the inquiry factors 114.

The processing device 104 may thereupon receive this solution information 116 and generate a solution document 118. FIG. 4 illustrates one example of a solution document 118. This document 118 may be an electronic file in one or more different formats readable by different applications. For example, the document 118 may be encoded in a mark-up language and viewable using a browser application. In another embodiment, the document 118 may be formatted in a postscript format and readable by a proprietary reading application.

Regardless of the formatting, the solution document 118 includes the solution information 116 received from the database 106. This information 116 may be assembled in any number of different scenarios, providing for the display of the information that is directed to the user inquiry 112. As illustrated in the exemplary document 118 of FIG. 4, the document includes header information 150, a recitation of the user inquiry 112, documentation information 152, previous solution documents 154, a list of qualified assistants 156 and routing information 158, as described in further detail below.

In the document 118, the information 112, 150, 152, 154, 156 and 158 may be specifically listed therein. In another embodiment, the information may include summaries or even active hyperlinks to original documents. For example, if there are numerous previous solution documents 154, a summary of the document may be listed along with an active link to the documents themselves stored in the database 144 of FIG. 3. Therefore, if an assistant wanted to access that particular solution document, clicking on the link would provide for the retrieval and display of the document within a networked or other computing environment.

The solution document 118 may also be generated with the routing information 158 therein. This information 158 within the document may be a display of noted experts or qualified persons capable of performing particular tasks or the information. Although, this routing information may also be utilized to provide the document 118 to one or more intended recipients.

After the document 118 is generated, the document 118 is provided to the routing device 108 and based on the routing information 158, the document 118 is transmitted in a message 120 to a support assistant 122. The routing information may be an electronic mail address or other indicator so that the routing device 108 can properly direct the message 120. The message 120 may be received across a network or other type of connection.

It is also noted that the routing information 158 may be to a group of persons instead of just one person. For example, a user problem may be assigned to a group and the members of the group are given the solution document 118 so that one or more persons in the group can then undertake assisting the user. In other embodiments, the message 120 may go to a queue or other processing device for the support assistant to later access. For example, if the message 120 is an electronic notification, the notification may be queued until the assistance retrieves the message 120 therefrom. In this example, the assistant 120 may, using a computer device, electronically view the solution document and through a network or other connection, retrieve any actively linked elements contained therein.

In one embodiment, the assistant 122 may thereupon contact the user that submitted the request. Communication between the assistant 122 and the user may be facilitated by a processing system for communication across a network, such as an internet telephone connection, a voice over internet protocol connection, a directed networking communication session or any other communication means.

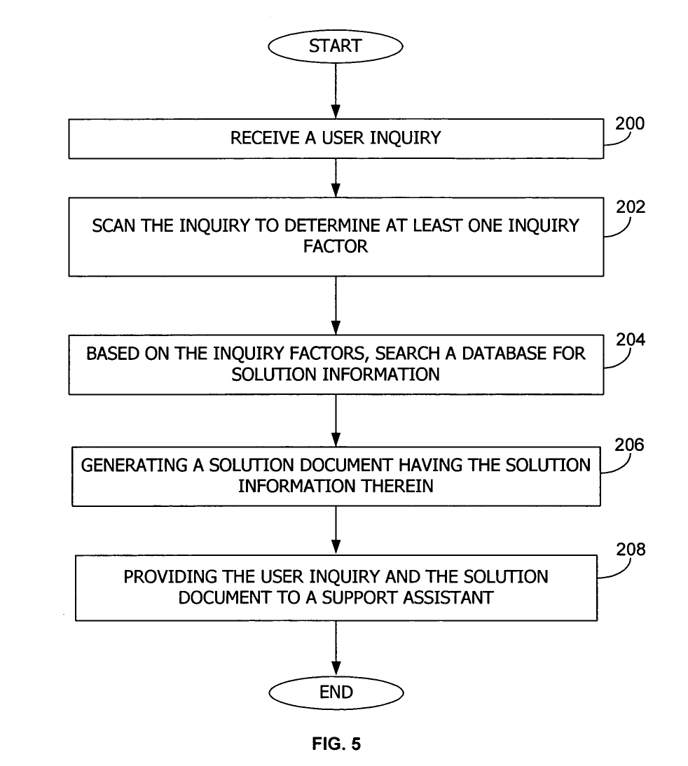

FIG. 5 illustrates the steps of a flowchart of a method for processing a user inquiry. The method begins, step 200, by receiving a user inquiry. The user inquiry may be received in a receiver 102 or other device capable of receiving an incoming message having a user inquiry contained therein. The next step, step 202 is scanning the inquiry to determine at least one inquiry factor. As discussed above in FIG. 2, one embodiment includes using a parser 120 to determine particular terms or phrases, such as based on a look-up table or other list of particular terms, and upon matching those terms, indicating these terms as inquiry factors.

The next step, step 204, is searching a database for solution information based on the inquiry factors. The database searching may performed using known database searching techniques. When a general database is used, the search may be performed using all of the inquiry factors. In another embodiment, when multiple databases are searched, specific inquiry factors may be directed to specific databases.

The next step, step 206, is generating a solution document having the solution information therein. As illustrated above in FIG. 4, the solution document 118 may include one more of the solution information retrieved from the database. The document 118 may also include reference to documents or even active links to documents, depending on various embodiments.

Furthermore, the contents of the solution document 118 may be governed by indicators of the relevance of the search using the inquiry factors. While the solution document may provide a direct resource to help the assistant, the document may also lose value should it include too much information. Therefore the search results may be rated for its relevance to the noted inquiry factors and selected accordingly. For example, if a user inquiry includes a type of software and version information, previous solution documents to older versions may be omitted from the solution document 118 as they may not necessarily be applicable.

The next step, step 208, is providing the user inquiry and the solution document to the support assistant. As discussed above, the solution document may include the user inquiry therein, but in other embodiments the user inquiry may be submitted separately. The recipient of the solution document and the user inquiry thereupon has the information relating to the user's concern, information relating to proposed solutions or other material for resolving the problem and contact information for the user. From this, the assistant may thereupon help the user.

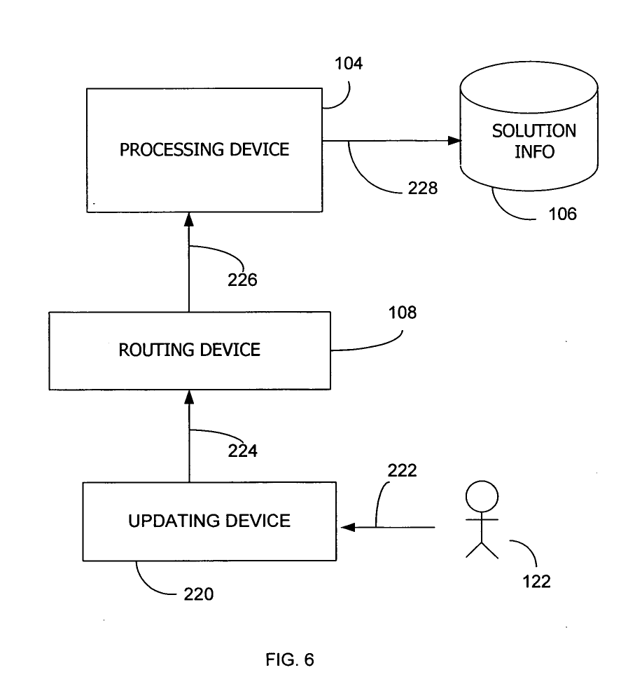

FIG. 6 illustrates a further embodiment of a user inquiry processing device. The solution documents provided to the user assistant includes information maintained by the assistants. Therefore, FIG. 6 illustrates an embodiment allowing the assistant to update or make notes regarding a solution document and that information to be added to the database from which the solution information is retrieved.

As illustrated, FIG. 6 includes the solution information database 106, the processing device 104, the routing device 108, the user assistant 122 and an updating device 220. The updating device 220 may be a computing device or other processing device that the assistant uses, for example a terminal computer connectable to a network. The updating device 220 also allows for the distribution of assistant-entered information back to the network and in some embodiments to the solution information database 106.

In the processes of working with the user, the assistant 122 may determine new things worth noting in the solution document. For example, the assistant 122 may have figured out an improved way to correct a bug or other concern in a software application. The assistant 122 may thereupon provide an input 222 to the updating device 220, for example typing information in to a memo section of a solution document or physically changing the solution document itself. This input 222 includes support assistant updates which include additional information updating the information already contained in the solution document (118 of FIG. 1).

Upon completion of updating the solution document, the assistant 122 may direct an updated message 224 to the routing device, where the message 224 includes an updated document 226 and routing information. Based on the routing information, the document 226 may thereupon be routed to the processing device 104. The processing device 104 may act as a central access point for the solution information database 106 and upon receipt, store the updated solution document 224 in the database by providing an update command 228 thereto. In a further example, the updated document 226 may be stored in a more specific database such as the previous solution documents database 144 of FIG. 3. Thereupon, the device of FIG. 6 allows for further updating of the information and the assistant to maintain the database 106 with current information acquired from actual experience dealing with customers.

In another embodiment, the update document 226 may be written directly to the appropriate database for updating the relevant information from the update device 220. The update device 220 may use the routing device 108 to direct the information or through a network connection the updated document 226 may be written directly therein. It is also noted that other databases may also be updated accordingly, for example a database having information on the experience level of different assistants may be updated to reflect the assistant's 122 ability with a particular issue as indicated by the newly generated document 226. Through the update device 220, the information used to generate the solution documents may be kept current, including the experience information assistants encountered when assisting related issues.

Therefore, the user inquiry, upon receipt form the user, is analyzed to determine particular key words or terms that make up the underlying concern. From these terms, the user inquiry may therefore be directed to an assistant with experience in a particular region and the user assistant is provided the solution document with relevant information extracted from databases. And through feedback options, the currency of the information may be maintained to provide highly effective customer support with directed documents provided by recognized qualified assistants.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A user inquiry processing device comprising:
a receiver for receiving a user inquiry;
a processing device coupled to the receiver and receiving the user inquiry therefrom, the processing device determining inquiry factors from the user inquiry;
a database coupled to the processing device such that the processing device searches the database to retrieve solution information based on the inquiry factors;
the processing device generating a solution document having the solution information therein; and
a routing device operative to route the solution document and user inquiry to a support assistant.

2. The device of claim 1 further comprising:
routing information stored in the database such that the support assistant is selected based on the inquiry factors and the solution document is routed based on this routing information.

3. The device of claim 2 wherein the routing information includes an identification of a plurality of assistants experienced with the user inquiry, as indicated by the inquiry factors.

4. The device of claim 1 further comprising:
a solution document database having a plurality of solution documents stored therein such that the solution document database is searchable using the inquiry factors.

5. The device of claim 1 further comprising:
a documentation database having a plurality of documentation stored therein such that the documentation database is searchable using the inquiry factors.

6. The device of claim 1 further comprising:
a communication device facilitating communication between the support assistant and a user submitting a user inquiry, wherein the communication is initiated based on contact information from the user inquiry.

7. The device of claim 1 wherein the solution document includes at least one of: active links to documentation, a list of experienced support assistances, related user inquiries and notes from the solution of previous inquiries.

8. The device of claim 1 wherein the solution information include at least one problem tree such that problem tree is retrievable based on the inquiry factors and routable to the support assistant to assist in diagnosing a user problem.

9. The device of claim 1 wherein the solution information includes at least one decision tree such that the decision tree is retrievable based on the inquiry factors and routable to the support assistant to assist in solving a user problem.

10. A method for determining and redirected a user inquiry, the method comprising:
receiving a user inquiry;
scanning the inquiry to determine at least one inquiry factors;
based on the inquiry factors, searching a database for solution information; and
generating a solution document having the solution information therein; and
providing the user inquiry and the solution document to a support assistant.

11. The method of claim 10 further comprising:
searching the database for routing information based on the inquiry factors; and
routing the user inquiry and the solution document to a selected support assistant based on at least the routing information.

12. The method of claim 11 wherein the routing information includes an identification of a plurality of assistants experienced with the user inquiry, as indicated by the inquiry factors.

13. The method of claim 10 further comprising:
searching a plurality of solution documents in a solution document database;
collecting associated solution documents as indicated by the inquiry factors.

14. The method of claim 10 further comprising:
searching a plurality of documentation in a documentation database; and
collecting associated documentation as indicated by the inquiry factors.

15. The method of claim 10 further comprising:
facilitating communication between a user submitted the user inquiry and the support assistant.

16. The method of claim 10 wherein the solution document includes at least one of: active links to documentation, a list of experienced support assistances, related user inquiries and notes from the solution of previous inquiries.

17. The method of claim 10 wherein the solution information include at least one problem tree, the method further comprising:
retrieving at least one problem tree based on the inquiry factors; and
routing the at least one problem tree to the support assistant to assist in diagnosing a user problem.

18. The method of claim 1 wherein the solution information includes at least one decision tree, the method further comprising:
retrieving at least one decision tree based on the inquiry factors; and
routing the at least one decision tree to the support assistant to assist in solving a user problem.

19. A user inquiry processing system comprising:
a processing device determining inquiry factors from a user inquiry;
a database coupled to the processing device such that the processing device searches the database to retrieve solution information based on the inquiry factors;
the processing device generating a solution document having the solution information therein;
a routing device operative to route the solution document and user inquiry to a support assistant;
an updating receiving input information from the support assistant to generate an updated solution document; and
the updating device providing for the storage of the updated solution document in the database.

20. The system of claim 19 further comprising:
routing information stored in the database such that the support assistant is selected based on the inquiry factors and the solution document is routed based on this routing information.

21. The system of claim 19 wherein the updated solution document is provided to the processing device for storage in the database.

22. The system of claim 19 further comprising:
a solution document database having a plurality of solution documents stored therein such that the solution document database is searchable using the inquiry factors; and
a documentation database having a plurality of documentation stored therein such that the documentation database is searchable using the inquiry factors.

23. The system of claim 19 wherein the solution document includes at least one of: active links to documentation, a list of experienced support assistances, related user inquiries and notes from the solution of previous inquiries and the updated solution document includes support assistant updates.
